(19) United States
(12) Patent Application Publication
(10) Pub. No.: US 2026/0063843 A1
(43) Pub. Date: Mar. 5, 2026

(54) OPTICAL COUPLING ARRANGEMENTS FOR CHIP CONNECTION ARRANGEMENTS BETWEEN DIFFERENT CHIPS OF AN INTEGRATED CIRCUIT SYSTEM

(71) Applicant: Ciena Corporation, Hanover, MD (US)

(72) Inventors: Lam Nguyen, Québec (CA); Simon Savard, Quebec (CA); Raphael Beaupré-Laflamme, Quebec (CA); Nicolas Boyer, Magog (CA)

(73) Assignee: Ciena Corporation, Hanover, MD (US)

(21) Appl. No.: 18/823,152

(22) Filed: Sep. 3, 2024

(51) Int. Cl. G02B 6/125; G02B 6/12; G02B 6/122; G02B 6/13

(52) U.S. Cl. CPC G02B 6/125; G02B 6/12004; G02B 6/1228; G02B 6/13

(57) ABSTRACT

An apparatus comprises: an interposer chip (IC) having a first layer with a first plurality of optical waveguiding structures (OWSs), where the first layer is below a surface of the IC substantially coplanar with a first plane; a device chip (DC) having a second layer with a second plurality of OWSs, where the second layer is below a surface of the DC substantially coplanar with a second plane; and a chip connection arrangement between the IC and the DC forming a nonzero angle between the first and second planes, where the chip connection arrangement comprises at least one optical coupling arrangement comprising a first cutout in the IC extending below the surface, and exposing an end of a first OWS, and a first protrusion extending from a portion of the DC, containing a portion of a bend in a second OWS, and exposing an end of the second OWS.

### TECHNICAL FIELD

This disclosure relates to optical coupling arrangements for chip connection arrangements between different chips of an integrated circuit system.

### BACKGROUND

Chip-scale devices and systems comprising integrated circuits (ICs) have applications ranging from electronics to optical connectivity. Increasing demand for integrated circuit systems has driven advancements in their operating capabilities, physical sizes, and reliability alongside optimization of associated manufacturing processes including production and testing. Some IC systems comprise electronic components configured to manipulate or transmit electric signals, while other IC systems comprise photonic structures or components configured to guide or manipulate electromagnetic waves. Some electromagnetic waves have a spectrum that has a peak wavelength that falls in a particular range of optical wavelengths (e.g., between about 100 nm to about 1 mm, or some subrange thereof), also referred to as optical waves, light waves, or simply light.

In some implementations, IC systems can comprise optical waveguiding structures configured to guide or manipulate electromagnetic waves that are in the optical wavelength region. Some integrated circuit systems comprise a mixture of electronic components and photonic components, leveraging the benefits of both technologies to enhance functionality and performance. Some IC systems can include multiple chips within a single package, where each chip can perform specialized functions. This multi-chip integration can allow for greater device capabilities for advanced applications.

In some examples, optimizing the design of IC systems can be associated with benefits including enhanced operational capabilities. Some IC system designs can also be associated with higher component densities and reduced physical footprints. Further, some IC systems can be designed to reduce power consumption and optimize thermal management associated with the IC system. For IC systems including multiple chips, the lengths of interconnects between the chips can be optimized to reduce losses associated with transmitting optical or electronic signals along the interconnects.

### SUMMARY

In one aspect, in general, an apparatus comprises: an interposer chip having a first layer within which a first plurality of optical waveguiding structures are arranged, where the first layer is below a surface of the interposer chip that is substantially coplanar with a first plane; a device chip having a second layer within which a second plurality of optical waveguiding structures are arranged, where the second layer is below a surface of the device chip that is substantially coplanar with a second plane; and a chip connection arrangement between the interposer chip and the device chip that forms a nonzero angle between the first plane and the second plane, where the chip connection arrangement comprises at least one optical coupling arrangement comprising a first cutout in the interposer chip extending below the surface of the interposer chip, and exposing an end of a first optical waveguiding structure in the first layer at an edge facet of the first cutout, and a first protrusion extending from a portion of the device chip, containing at least a portion of a bend in a second optical waveguiding structure in the second layer, and exposing an end of the second optical waveguiding structure at an edge facet of the first protrusion.

Aspects can include one or more of the following features.

The chip connection arrangement further comprises an index matching material between the edge facet of the first cutout and the edge facet of the first protrusion having an index of refraction that matches within 20% an index of refraction of at least a portion of the first optical waveguiding structure and matches within 20% an index of refraction of at least a portion of the second optical waveguiding structure.

The chip connection arrangement comprises a plurality of optical coupling arrangements, each optical coupling arrangement comprising: a cutout in the interposer chip extending below the surface of the interposer chip, and exposing an end of a different respective optical waveguiding structure in the first layer at an edge facet of the first cutout, and a protrusion extending from a portion of the device chip, containing at least a portion of a bend in a different respective optical waveguiding structure in the second layer, and exposing an end of the different respective optical waveguiding structure at an edge facet of the protrusion.

The first waveguiding structure and the second waveguiding structure each comprise a spot size converter, where each spot size converter configured to transform a cross-section associated with an electromagnetic wave propagating in the respective waveguiding structure.

The interposer chip further comprises a first plurality of metal contacts arranged on the surface of the interposer chip and the device chip further comprises a second plurality of metal contacts arranged on the surface of the device chip, where one or more of the second plurality of metal contacts extends to an edge of the device chip.

Each of the metal contacts that extend to an edge of the device chip is connected by a conductive structure to a respective metal contact in the first plurality of metal contacts.

Each of the metal contacts that extend to an edge of the device chip has a carveout that is filled by the conductive structure.

The apparatus further comprises a first metal contact and a second metal contact in the first plurality of metal contacts on the surface of the interposer chip arranged along an axis that is coplanar with the first plane and a third plane that is perpendicular to the first plane, where the second metal contact is further from the second plane than the first metal contact, a third metal contact and a fourth metal contact in the second plurality of metal contacts on the surface of the device chip arranged along an axis that is coplanar with second plane and the third plane, where the fourth metal contact is further from the first plane than the third metal contact, a first conducting structure connecting the first metal contact to the third metal contact, and a second conducting structure connecting the second metal contact to the fourth metal contact, wherein the first conducting structure and the second conducting structure are separated by an insulator.

The apparatus further comprises a plurality of device chips, each device chip having a layer within which a plurality of optical waveguiding structures are arranged, where the layer is below a surface of the respective device chip that is substantially coplanar with a respective plane; and a plurality of chip connection arrangements between a respective device chip of the plurality of device chips and the interposer chip that each forms a nonzero angle between the first plane and a respective plane associated with the respective device chip, where each chip connection arrangement comprises at least one optical coupling arrangement comprising a cutout in the interposer chip extending below the surface of the interposer chip, and exposing an end of a different respective optical waveguiding structure in the first layer at an edge facet of the cutout, and a protrusion extending from a portion of the respective device chip, containing at least a portion of a bend in a different respective optical waveguiding structure in the layer of the respective device chip, and exposing an end of the different respective optical waveguiding structure at an edge facet of the protrusion.

Each chip connection arrangement in the plurality of chip connection arrangements comprises an index matching material between the edge facet of the cutout and the edge facet of the respective protrusion, the index matching material having an index of refraction that matches within 20% an index of refraction of at least a portion of the optical waveguiding structure associated with the cutout and matches within 20% an index of refraction of at least a portion of the respective optical waveguiding structure associated with the protrusion.

Each nonzero angle of the plurality of chip connection arrangements is 90 degrees.

In another aspect, in general, a method comprises: preparing a surface and a first layer of an interposer chip, where the surface of the interposer chip is substantially coplanar with a first plane and the first layer is below the surface of the interposer chip, by arranging a plurality of metal contacts on the surface of the interposer chip, a plurality of optical waveguiding structures in the first layer, and one or more cutout structures that extend from the surface of the interposer chip to the first layer and expose an end of a different respective optical waveguiding structure; preparing a surface and a second layer of a device chip, where the surface of the device chip is substantially coplanar with a second plane and the second layer is below the surface of the device chip, by arranging a plurality of metal contacts on the surface of the device chip, a plurality of optical waveguiding structures in the second layer, and one or more protrusions extending from the device chip, where each protrusion contains at least a portion of a bend in a different respective optical waveguiding structure in the second layer and exposes an end of the optical waveguiding structure; aligning the surface of the interposer chip and the surface of the device chip such that the first plane and the second plane form a nonzero angle; aligning each of one or more protrusions of the device chip with a respective cutout structure on the surface of the interposer chip; receiving alignment feedback associated with a coupling of ends of the optical waveguiding structures in the one or more protrusions to respective ends of the optical waveguiding structures exposed by the one or more cutout structures; forming at least one connective structure between the device chip and the interposer chip based at least in part on the alignment feedback; and forming a plurality of conductive structures between each of the metal contacts on the surface of the interposer chip and a respective metal contact on the surface of the device chip.

Aspects can include one or more of the following features.

The method further comprises depositing a passivation layer on each of the conductive structures.

The alignment feedback is associated with a coupling of ends of the optical waveguiding structures in two or more protrusions to respective ends of the optical waveguiding structures exposed by two or more cutout structures.

The connective structure comprises ink, adhesive, or tacking fluid.

An index matching material is placed between each of the ends of the optical waveguiding structures in the cutouts and the respective ends of the optical waveguiding structures in the protrusions.

One or more optical waveguiding structures of the interposer chip comprise a spot-size converter configured to modify a cross-sectional area of an electromagnetic wave propagating through the respective optical waveguiding structure.

The alignment feedback is associated with an electromagnetic wave propagating through one or more optical waveguiding structures of the interposer chip.

One or more optical waveguiding structures of the interposer chip comprise a Sagnac loop.

The conductive structures are deposited on the metal contacts arranged on the surface of the interposer chip before the surface of the interposer chip and the surface of the device chip are aligned.

Aspects can have one or more of the following advantages.

The methods and systems disclosed herein can be utilized to produce IC systems comprising multiple chips each with photonic or electro-optical components arranged on their surface. Some of the methods disclosed herein can be utilized to align multiple photonic structures associated with one chip to multiple photonic structures associated with another chip. In some examples, the arrangement of multiple chips can be associated with more efficient thermal management and a lower net power consumption for a device architecture. In addition, some methods and systems disclosed herein can allow for the production of heterogenous IC systems comprising chips made of different materials.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1B are schematic diagrams of an example integrated circuit system comprising a chip coupling arrangement.

FIGS. 2A-2B are schematic diagrams of an example integrated circuit system comprising a chip coupling arrangement.

FIGS. 3A-3B are schematic diagrams of an example integrated circuit system comprising a chip coupling arrangement.

FIGS. 4A-4B are schematic diagrams of an example integrated circuit system.

FIG. 5 is a schematic diagram of an example chip coupling arrangement.

FIGS. 6A-6B are schematic diagrams of an example integrated circuit system.

FIGS. 7A-7C are schematic diagrams of an example integrated circuit system.

FIGS. 8A-8C are schematic diagrams of example metal contacts.

### DETAILED DESCRIPTION

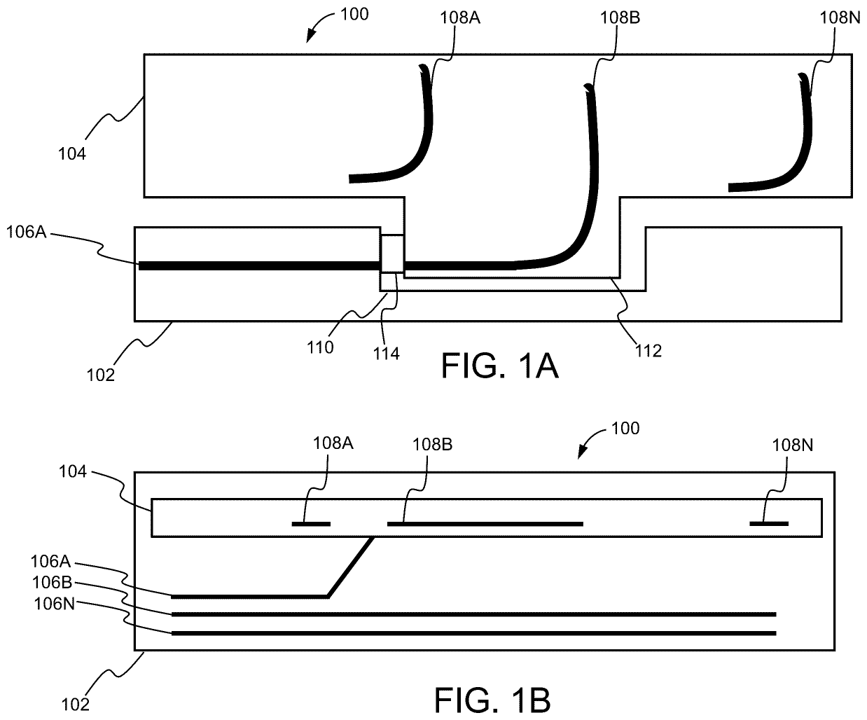

Some integrated circuit (IC) devices can comprise an interposer chip having a surface that is substantially coplanar with a first plane and one or more device chips each having a respective surface that is substantially coplanar with a respective plane. In some implementations, a nonzero angle can be formed by the first plane and each plane associated with a respective device chip. FIG. 1A depicts a side view of an example IC system 100 comprising an interposer chip 102 and a device chip 104. In this side view, the narrow edge of the interposer chip 102 is shown and a portion of the broad side of the device chip 104 is shown. In this example, the nonzero angle is an angle of approximately 90 degrees. FIG. 1B depicts a top view of the integrated circuit system 100. In this top view, the narrow edge of the device chip is shown and a portion of the broad side of the interposer chip 102 is shown. The interposer chip 102 has a first layer within which a plurality of optical waveguiding structures 106A-106N are arranged, where the first layer is below a surface of the interposer chip 102 that is substantially coplanar with a first plane. The device chip 104 has a second layer within which a second plurality of optical waveguiding structures 108A-108N are arranged, where the second layer is below a surface of the device chip that is substantially coplanar with a second plane. The interposer chip 102 and the device chip 104 are connected with a chip connection arrangement that forms a nonzero angle between the first plane and the second plane. The chip connection arrangement includes at least one optical coupling arrangement comprising a first cutout 110 in the interposer chip 102 extending below the surface of the interposer chip 102 and exposing an end of the optical waveguiding structure 106A in the first layer at an edge facet of the first cutout 110. The optical coupling arrangement also comprises a first protrusion 112 extending from a portion of the device chip 104 containing at least a portion of a bend in an optical waveguiding structure 108B in the second layer and exposing an end of the optical waveguiding structure 108B at an edge facet of the first protrusion 112.

In some chip connection arrangements, an index matching material 114 can be included between the edge facet of the first cutout 110 and the edge facet of the first protrusion 112. This index matching material 114 can have an index of refraction that matches within a certain range an index of refraction of at least a portion of the optical waveguiding structure 106A and matches within a certain range an index of refraction of at least a portion of the optical waveguiding structure 108B. For example, an index of refraction of the index matching material 114 can match either or both of the other indices of refraction within a certain range such as within 5%, 10%, or 20%. In some examples, the index matching material 114 can be an optical adhesive that minimizes reflection losses and provides mechanical strength.

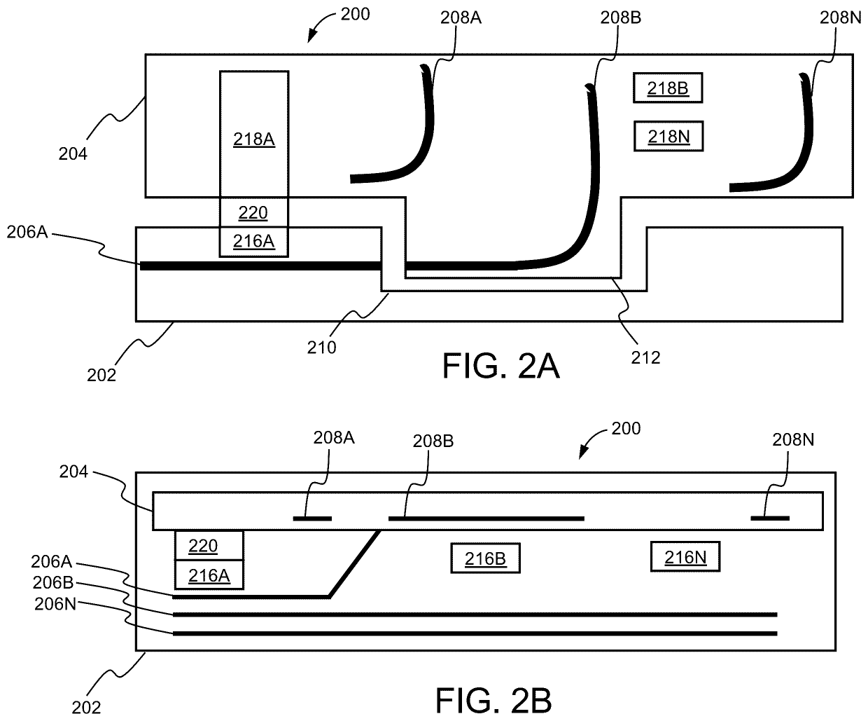

In some integrated circuit systems one or more metal contacts can be arranged over the surface of a device chip and an interposer chip. FIG. 2A depicts a side view of an example integrated circuit system 200 comprising an interposer chip 202 and a device chip 204. FIG. 2B depicts a top view of the integrated circuit system 200. The interposer chip 202 has a first layer within which a plurality of optical waveguiding structures 206A-206N are arranged, where the first layer is below a surface of the interposer chip 202 that is substantially coplanar with a first plane. The interposer chip 202 further comprises a first plurality of metal contacts 216A-216N arranged over the surface of the interposer chip 202. The device chip 204 has a second layer within which a second plurality of optical waveguiding structures 208A-208N are arranged, where the second layer is below a surface of the device chip that is substantially coplanar with a second plane. The device chip 204 further comprises a second plurality of metal contacts 218A-218N arranged on the surface, with a metal contact 218A extending to an edge. The interposer chip 202 and the device chip 204 are connected with a chip connection arrangement that forms a nonzero angle between the first plane and the second plane. The chip connection arrangement includes at least one optical coupling arrangement comprising a first cutout 210 in the interposer chip 202 extending below the surface of the interposer chip 202 and exposing an end of the optical waveguiding structure 206A in the first layer at an edge facet of the first cutout 210. The optical coupling arrangement also comprises a first protrusion 212 extending from a portion of the device chip 204 containing at least a portion of a bend in an optical waveguiding structure 208B in the second layer and exposing an end of the optical waveguiding structure 208B at an edge facet of the first protrusion 212. The metal contact 218A is connected to the metal contact 216A by a conductive structure 220.

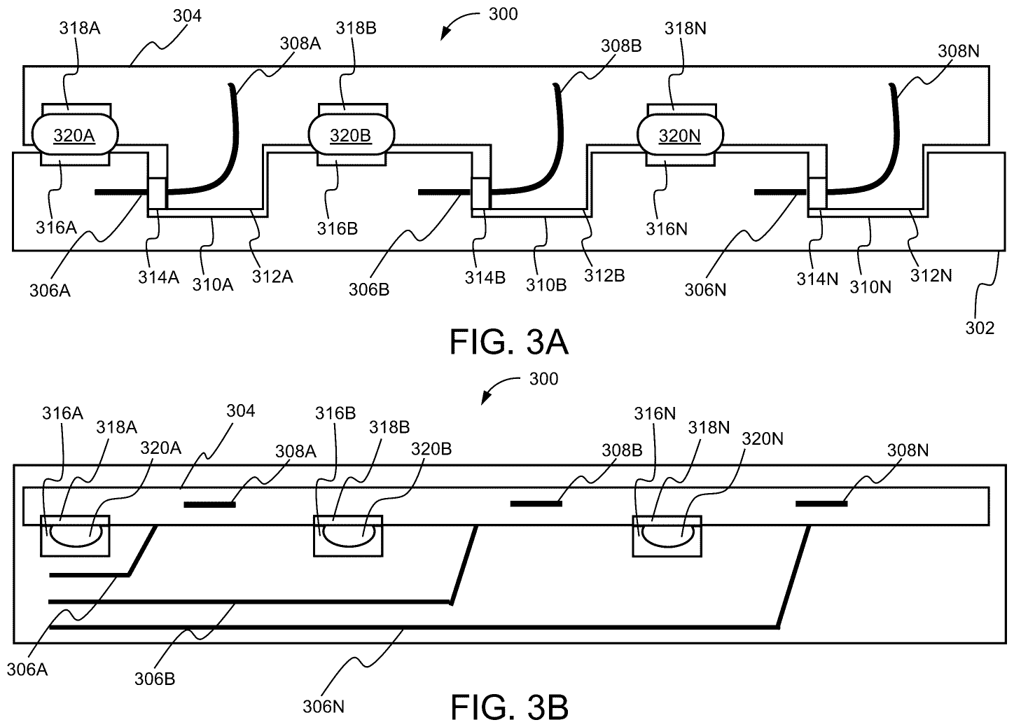

Some IC systems can comprise a device chip and an interposer chip with a chip connection arrangement that comprises a plurality of optical coupling arrangements. FIG. 3A depicts a side view of an example integrated circuit system 300 comprising an interposer chip 302 and a device chip 304. FIG. 3B depicts a top view of the integrated circuit system 300. The interposer chip 302 has a first layer within which a plurality of optical waveguiding structures 306A-306N are arranged, where the first layer is below a surface of the interposer chip 302 that is substantially coplanar with a first plane. The interposer chip 302 further comprises a first plurality of metal contacts 316A-316N arranged over the surface of the interposer chip 302. The device chip 304 has a second layer within which a second plurality of optical waveguiding structures 308A-308N are arranged, where the second layer is below a surface of the device chip that is substantially coplanar with a second plane. The device chip 304 further comprises a second plurality of metal contacts 318A-318N arranged on the surface and extending to an edge. The interposer chip 302 and the device chip 304 are connected with a chip connection arrangement that forms a nonzero angle between the first plane and the second plane. The chip connection arrangement includes a plurality of optical coupling arrangements comprising a plurality of cutouts 310A-310N in the interposer chip 302 extending below the surface of the interposer chip 302 and exposing an end of a different respective optical waveguiding structure 306A-306N in the first layer at an edge facet of a respective cutout 310A-310N. The optical coupling arrangement also comprises a plurality of protrusions 312A-312N extending from a portion of the device chip 304. Each protrusion 312A-312N contains at least a portion of a bend in a different respective optical waveguiding structure 308A-308N in the second layer and exposing an end of the different respective optical waveguiding structure 308A-308N at an edge facet of the respective protrusion 312A-312N. Each optical coupling arrangement also comprises an index matching material 314A-314N. Each metal contact 318A-318N is connected to a respective metal contact 316A-316N by a respective conductive structure 320A-320N.

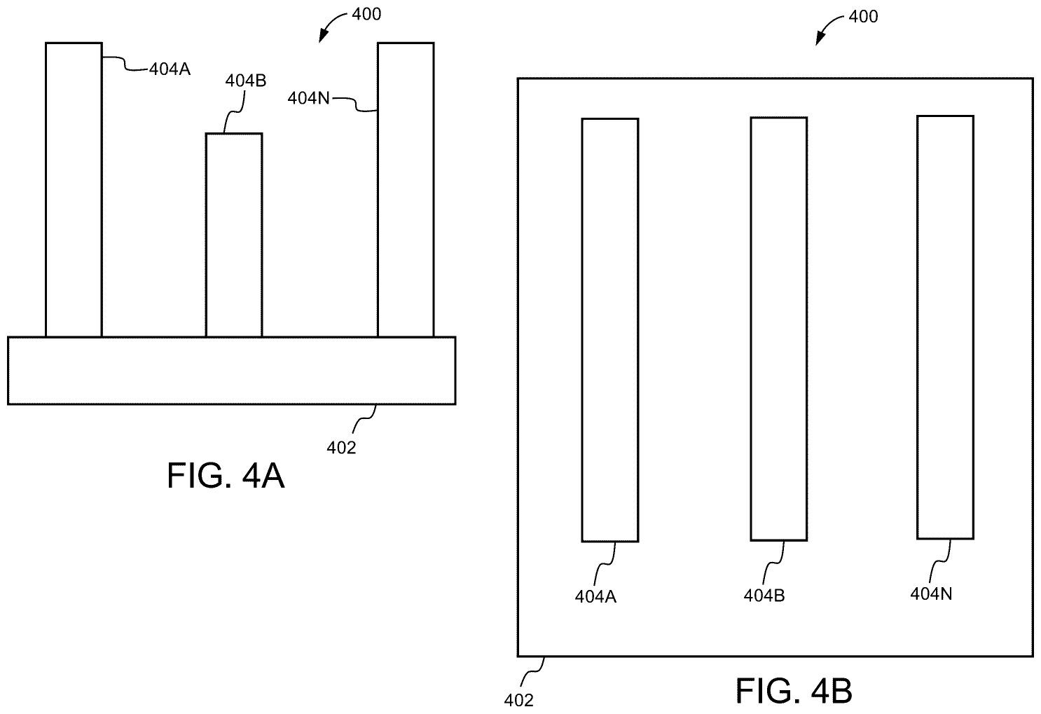

Some IC systems can comprise multiple device chips connected to an interposer chip. FIG. 4A depicts a front view of an example IC system 400 comprising an interposer chip 402 and a plurality of device chips 404A-404N. The interposer chip 402 can have a plurality of optical waveguiding structures (not shown) arranged in a layer below a surface of the interposer chip that is coplanar with a first plane. Each device chip 404A-404N can have a plurality of optical waveguiding structures (not shown) arranged in a layer below a surface of the device chip 404A-404N that is coplanar with a plane. Each device chip 404A-404N can be connected to the interposer chip 402 with a respective chip coupling arrangement such as depicted in FIGS. 1A-1B, FIGS. 2A-2B, or FIGS. 3A-3B. In some implementations, integrated multiple device chips with an interposer chip can reduce a physical footprint associated with each device chip and allow for higher assembly density.

An IC system can comprise interposer chips and device chips having varying numbers of optical waveguiding structures arranged in associated layers and having varying numbers of metal contacts arranged on the surfaces. While the IC system 300 shown in FIGS. 3A and 3B have the metal contacts arranged on one surface of the device chip device, the metal contacts can be arranged on either surface of the device chip. In some implementations, some of the optical coupling arrangements can comprise an index matching material while other optical coupling arrangements can not include an index matching materials.

In some examples, each nonzero angle formed by a plane that is coplanar with a surface of an interposer chip and a plane that is coplanar with a surface of a device chip can be 90 degrees such that each device chip is perpendicular to the surface of the interposer chip. In some examples, some nonzero angles that are formed by a plane that is coplanar with a surface of an interposer chip and a plane that is coplanar with a surface of a device chip can be less than or greater than 90 degrees. In some examples, some nonzero angles formed by a plane that is coplanar with a surface of an interposer chip and a plane that is coplanar with a surface of a device chip can be determined based on coupling between optical waveguiding structures associated with a device chip and optical waveguiding structures associated with an interposer chip.

Some device chips can comprise one or more optical waveguiding structures that include structures configured to facilitate coupling with respective optical waveguiding structures of an interposer chip. For instance, each of the optical waveguiding structures associated with an interposer chip and each of the optical waveguiding structures associated with a device chip can comprise spot size converters to increase the mode size associated with optical waves propagating through the structures. The inclusion of these spot size converters can aid in optical alignment and coupling between optical waveguiding structures of an interposer chip and optical waveguiding structures of a device chip.

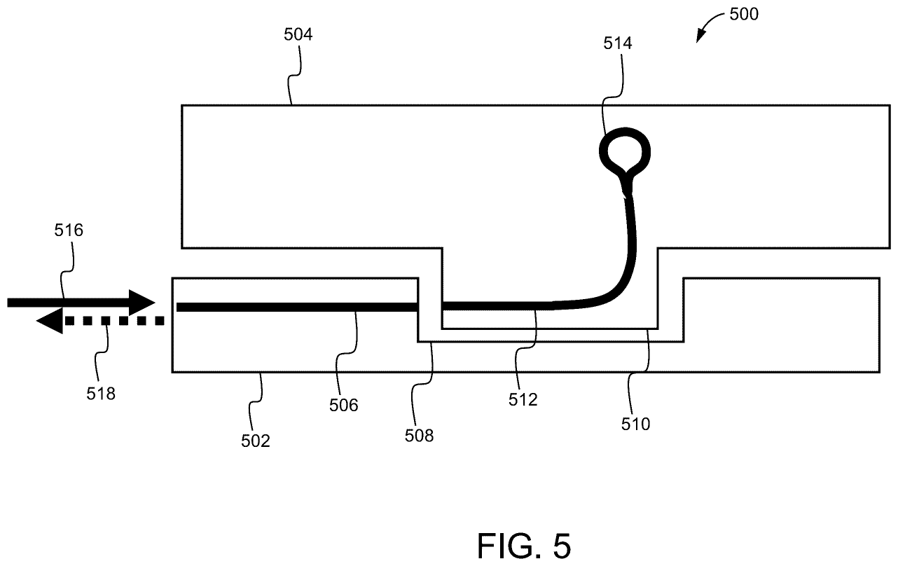

Other structures can also be included in optical waveguiding structures to facilitate coupling between optical waveguiding structures. FIG. 5 depicts a side view of an example IC system 500 comprising an interposer chip 502 and a device chip 504. The interposer chip 502 comprises an optical waveguiding structure 506 having an end is exposed at an edge facet of a cutout 508. The device chip 504 comprises a protrusion 510 that contains a portion of a bend of an optical waveguiding structure 512. An end of the optical waveguiding structure 512 is exposed at an edge facet of the protrusion 510. The optical waveguiding structure 512 includes a structure 514. An optical wave 516 coupled into the optical waveguiding structure 506 can be coupled into the optical waveguiding structure 512, propagate through the structure 514, and then propagate back through the optical waveguiding structure 512 and the optical waveguiding structure 506. The backwards propagating optical wave 518 can be measured. While the optical waves are shown spatially separated in FIG. 5 for clarity of illustration, the optical waves could be spatially overlapped at the input/output location and separated at a different location (e.g., at an optical circulator).

In some implementations, a backwards propagating optical wave 518 can provide alignment feedback associated with the coupling between optical waveguiding structure 512 and the optical waveguiding structure 506. In some implementations, the coupling between optical waveguiding structure 512 and the optical waveguiding structure 506 can be optimized based at least in part on the alignment feedback. In some examples, this optimization can include maximizing an optical power associated with the backwards propagating wave 518. In some implementations, the position of the device chip 504 or the interposer chip 502 relative to the other chip can be based at least in part on a measurement of the backwards propagating optical wave 518. In some implementations, the position of the edge facet containing the end of the optical waveguiding structure 506 and the position of the edge facet containing the optical waveguiding structure 512 can be swept while monitoring the backwards propagating optical wave 518 to find an optimum coupling. Some distances between edge facets can be on the order of ums. In some implementations, the nonzero angle formed by a plane coplanar with a surface of the interposer chip and a plane coplanar with a surface of the device chip can be determined and fixed based on a measurement of the backwards propagating optical wave 518.

In some implementations, the structure 514 can comprise a Sagnac loop (also referred to as a ring reflector) or a vertical etched mirror structure. In some implementations, the structure 514 can be insensitive to a polarization associated with an optical wave propagating through an optical waveguiding structure.

Some device chips can comprise a plurality of optical waveguiding structures that each comprise a structure configured to provide alignment feedback. In such implementations, alignment feedback from one or more of the structures can be utilized to optimize coupling between each optical waveguiding structure of the device chip and a respective optical waveguiding structure of an interposer chip. Some device chips can comprise a plurality of optical waveguiding structures and a plurality of protrusions, with a portion of each optical waveguiding structure contained in a respective protrusion and having an end exposed by an edge facet of the respective protrusion. In such implementations, two optical waveguiding structures including structures configured to provide alignment feedback can be positioned at opposite ends of the device chip. Alignment feedback from the two optical waveguiding structures can be utilized to optimize the coupling between each of the plurality of the optical waveguiding structures of the device chip with a respective optical waveguiding structure of an interposer chip.

In some integrated circuit systems, conductive structures associated with metal contacts can be formed based at least in part on alignment feedback associated with coupling optical structures. In some examples, one or more conductive structures can be placed on metal contacts associated with a device chip or metal contacts associated with an interposer chip and alignment of optical waveguiding structures associated with each can be performed. The conductive structures can then be heated to form a permanent interconnect.

In some implementations, the conductive structures can comprise a metal loaded ink, such as a silver or silver-filled ink, that can form a connection between metal contacts. In some examples, the silver ink can be deposited on metal contacts of a device chip before the device chip is rotated vertically and aligned with an interposer chip. The silver ink on each metal contact of a device chip can wet a respective metal contact of a device chip and form a joint to compensate for misalignment between the metal contacts. The viscosity and surface tension associated with the ink can be enough to maintain the nonzero angle between the device chip and the interposer chip. In some implementations, silver-filled ink can be deposited on metal contacts using an additive manufacturing techniques such as aerosol jet printing. Some inks sinter at a temperature between 100° C. and 200° C. and can create permanent metal interconnects. In some examples, this low sintering temperature can be compatible with temperature sensitive optoelectronic devices, can induce less internal stress in the device assembly, and/or can result in less displacement associated with coefficient of thermal expansion mismatches during device assembly. The low temperature processing can also be associated with reduced misalignment between optical waveguiding structures during device assembly.

In some implementations, a conductive structure can comprise solder. Some conductive structures comprising solder can be deposited on a metal contact of an interposer chip before optical alignment is performed. Following optical alignment, the solder can be heated in a reflow process to form a conductive structure connecting metal contacts. Some solder can comprise one or more materials including lead, copper, tin-silver alloys, or other tin alloys.

In some implementations, a passivation layer, such as an epoxy, can be deposited on top of a conductive structure to prevent degradation of the conductive structure.

In some implementations, the metal contacts of a device chip and/or an interposer chip can be treated before conductive structures are attached. In some examples, these treatments can include plasma cleaning, ozone cleaning, or other techniques to improve the cleanliness and/or wettability of the metal contacts.

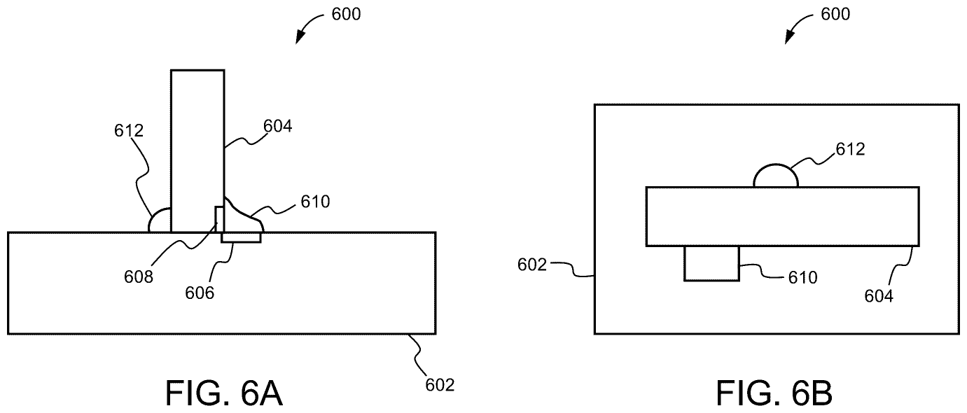

In some implementations, a tacking agent can be added to one or more surfaces of a device chip or interposer chip to provide stability or extra mechanical support during an optical alignment process. A tacking agent can also equilibrate capillary forces to prevent tilting of a device chip. FIG. 6A depicts a front view of an example IC system 600 comprising an interposer chip 602 and a device chip 604. FIG. 6B depicts a top view of the IC system 600. The interposer chip 602 comprises a metal contact 606 arranged on a surface and the device chip 604 comprises a metal contact 608 arranged on a surface. The metal contact 606 and the metal contact 608 are connected by a conductive structure 610. A tacking agent 612 is also included. In some implementations, tacking agents can include an adhesive, ink, UV-curable adhesive, or a metal-based solder. In some implementations, an adhesive can be cured based at least in part on some feedback or before the conductive structures are formed. In some implementations, a plurality of tacking agents can be utilized to provide support or stability.

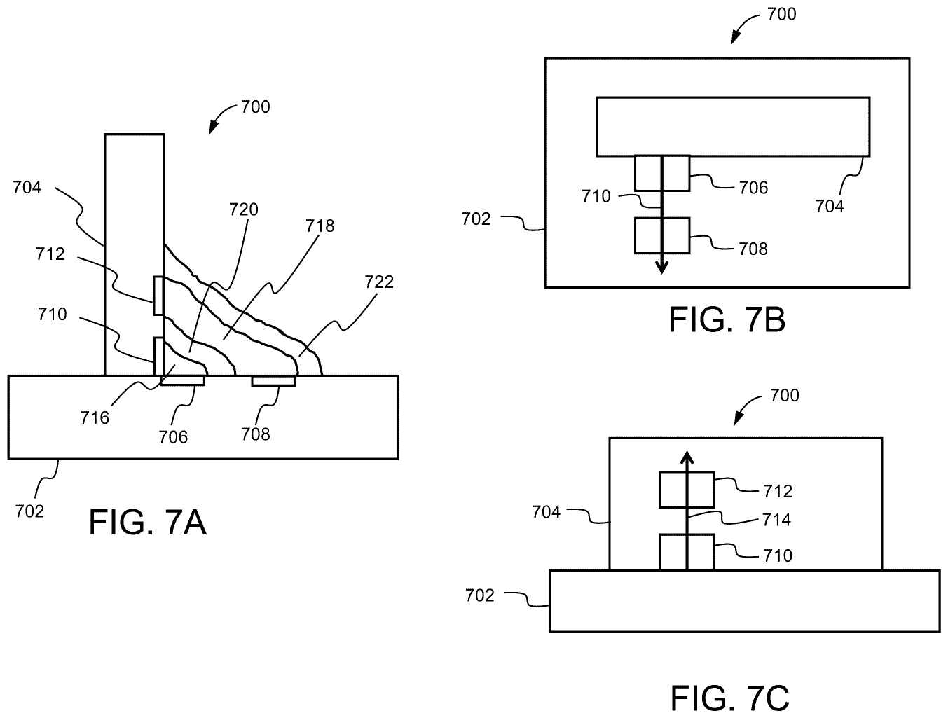

Some device chips and interposer chips can comprise more complex arrangements of metal contacts and conductive structures. FIG. 7A depicts a front view of an example IC system 700 comprising an interposer chip 702 and a device chip 704. FIG. 7B depicts a top view of the IC system 700 and FIG. 7C depicts a side view of the IC system 700. The interposer chip 702 has a surface that is substantially coplanar with a first plane and the device chip 704 has a surface that is substantially coplanar with a second plane. The first plane and the second plane form a nonzero angle. The interposer chip 702 comprises a plurality of metal contacts arranged on the surface of the interposer chip 702. The plurality of metal contacts of the interposer chip 702 includes a first metal contact 706 and a second metal contact 708 arranged along an axis 710 that is coplanar with the first plane and a third plane that is perpendicular to the first plane. The second metal contact 708 is further from the second plane than the first metal contact 706. The device chip 704 comprises a plurality of metal contacts arranged on the surface of the device chip 704. The plurality of metal contacts of the device chip 704 includes a third metal contact 710 and a fourth metal contact 712 arranged along an axis 714 that is coplanar with second plane and the third plane. The fourth metal contact 712 is further from the first plane than the third metal contact 710. A first conductive structure 716 connects the first metal contact 706 and the third metal contact 710. A second conductive structure 718 connects the second metal contact 708 and the fourth metal contact 712. The first conductive structure 716 and the second conductive structure 718 are separated by an insulator 720. A passivation layer 722 is included on top of the second conductive structure 718.

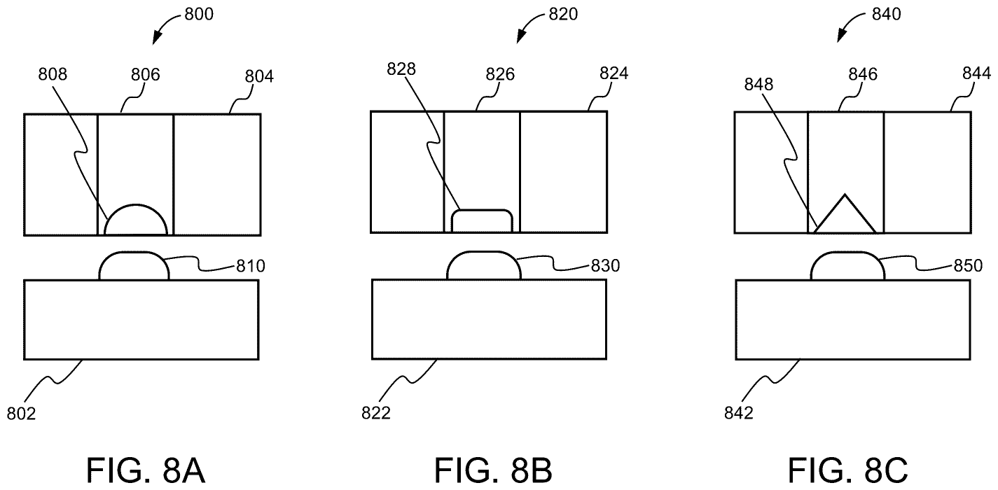

Some metal contacts can comprise carveouts such that an associated conductive structure can fill the carveout. FIGS. 8A-8C depict side views of example IC systems 800, 820, 840 comprising metal contacts with carveouts. The IC system 800 comprises an interposer chip 802 and a device chip 804. The device chip 804 includes a metal contact 806 with a carveout 808 that has a half-cylinder shape. A conductive structure 810 is deposited on a metal contact (not shown) on the surface of the interposer chip 802. The IC system 820 comprises an interposer chip 822 and a device chip 824. The device chip 804 includes a metal contact 826 with a carveout 828 that has a rounded rectangular shape. A conductive structure 830 is deposited on a metal contact (not shown) on the surface of the interposer chip 822. The IC system 840 comprises an interposer chip 842 and a device chip 844. The device chip 844 includes a metal contact 846 with a carveout 848 that has a triangular shape. A conductive structure 850 is deposited on a metal contact (not shown) on the surface of the interposer chip 842. Other carveout shapes are also possible. In some implementations, castellations and metal contacts associated with the conductive structure can be lithographically defined to provide a very tight and precise pitch.

In some implementations, an IC system can comprise an interposer chip and multiple device chips that are composed of different materials. In such implementations, an IC system can include heterogenous integration of multiple IC technologies. For instance, an IC system can comprise device chips with lasers or amplifiers fabricated on III-V semiconductor platforms such as gallium nitride or gallium arsenide. Some IC systems can include interposer chips that are barium titanate oxide (BTO), silicon, or thin film lithium niobate (TFLN) optical host chips. In some implementations, an IC system can optimize for capabilities associated with several IC technologies and combine those capabilities in the same device package. In some implementations, a metal contact can also extend to both surfaces of a device chip or an interposer chip.

Some IC systems can also include multi-project dies comprising multiple “chiplets.” Electrical and optical ICs can also be designed and assembled as “chiplets” and mounted vertically in the required configuration thus offering a modular approach based on the same architecture covering multiple applications.

In some implementations, the metal pads can comprise a material such as aluminum or copper. Layers of other materials such as a reflow-compatible nickel-gold finish can also be deposited on one or more metal contacts.

In some examples, vertical integration of one or more device chips and an interposer chip in an IC system can expose a broader surface of the device chip to air, allowing for a more efficient thermal management compared to a horizontally attached device chip. This thermal management can result in decreased net power consumption associated with the IC system.

In some implementations, protrusions of a device chip can be formed using techniques such as stealth dicing or laser microjet. In some implementations, cutouts of an interposer chip can be formed using a technique such as deep reactive ion etching (DRIE).

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
an interposer chip having a first layer within which a first plurality of optical waveguiding structures are arranged, where the first layer is below a surface of the interposer chip that is substantially coplanar with a first plane;
a device chip having a second layer within which a second plurality of optical waveguiding structures are arranged, where the second layer is below a surface of the device chip that is substantially coplanar with a second plane; and
a chip connection arrangement between the interposer chip and the device chip that forms a nonzero angle between the first plane and the second plane, where the chip connection arrangement comprises at least one optical coupling arrangement comprising
a first cutout in the interposer chip extending below the surface of the interposer chip, and exposing an end of a first optical waveguiding structure in the first layer at an edge facet of the first cutout, and
a first protrusion extending from a portion of the device chip, containing at least a portion of a bend in a second optical waveguiding structure in the second layer, and exposing an end of the second optical waveguiding structure at an edge facet of the first protrusion.

2. The apparatus of claim 1, wherein the chip connection arrangement further comprises an index matching material between the edge facet of the first cutout and the edge facet of the first protrusion having an index of refraction that matches within 20% an index of refraction of at least a portion of the first optical waveguiding structure and matches within 20% an index of refraction of at least a portion of the second optical waveguiding structure.

3. The apparatus of claim 1, wherein the chip connection arrangement comprises a plurality of optical coupling arrangements, each optical coupling arrangement comprising:
a cutout in the interposer chip extending below the surface of the interposer chip, and exposing an end of a different respective optical waveguiding structure in the first layer at an edge facet of the first cutout, and
a protrusion extending from a portion of the device chip, containing at least a portion of a bend in a different respective optical waveguiding structure in the second layer, and exposing an end of the different respective optical waveguiding structure at an edge facet of the protrusion.

4. The apparatus of claim 1, wherein the first waveguiding structure and the second waveguiding structure each comprise a spot size converter, where each spot size converter configured to transform a cross-section associated with an electromagnetic wave propagating in the respective waveguiding structure.

5. The apparatus of claim 1, wherein the interposer chip further comprises a first plurality of metal contacts arranged on the surface of the interposer chip and the device chip further comprises a second plurality of metal contacts arranged on the surface of the device chip, where one or more of the second plurality of metal contacts extends to an edge of the device chip.

6. The apparatus of claim 5, wherein each of the metal contacts that extend to an edge of the device chip is connected by a conductive structure to a respective metal contact in the first plurality of metal contacts.

7. The apparatus of claim 6, wherein each of the metal contacts that extend to an edge of the device chip has a carveout that is filled by the conductive structure.

8. The apparatus of claim 5, further comprising
a first metal contact and a second metal contact in the first plurality of metal contacts on the surface of the interposer chip arranged along an axis that is coplanar with the first plane and a third plane that is perpendicular to the first plane, where the second metal contact is further from the second plane than the first metal contact,
a third metal contact and a fourth metal contact in the second plurality of metal contacts on the surface of the device chip arranged along an axis that is coplanar with second plane and the third plane, where the fourth metal contact is further from the first plane than the third metal contact,
a first conducting structure connecting the first metal contact to the third metal contact, and
a second conducting structure connecting the second metal contact to the fourth metal contact,
wherein the first conducting structure and the second conducting structure are separated by an insulator.

9. The apparatus of claim 1, further comprising
a plurality of device chips, each device chip having a layer within which a plurality of optical waveguiding structures are arranged, where the layer is below a surface of the respective device chip that is substantially coplanar with a respective plane; and
a plurality of chip connection arrangements between a respective device chip of the plurality of device chips and the interposer chip that each forms a nonzero angle between the first plane and a respective plane associated with the respective device chip, where each chip connection arrangement comprises at least one optical coupling arrangement comprising
a cutout in the interposer chip extending below the surface of the interposer chip, and exposing an end of a different respective optical waveguiding structure in the first layer at an edge facet of the cutout, and
a protrusion extending from a portion of the respective device chip, containing at least a portion of a bend in a different respective optical waveguiding structure in the layer of the respective device chip, and exposing an end of the different respective optical waveguiding structure at an edge facet of the protrusion.

10. The apparatus of claim 9, wherein each chip connection arrangement in the plurality of chip connection arrangements comprises an index matching material between the edge facet of the cutout and the edge facet of the respective protrusion, the index matching material having an index of refraction that matches within 20% an index of refraction of at least a portion of the optical waveguiding structure associated with the cutout and matches within 20% an index of refraction of at least a portion of the respective optical waveguiding structure associated with the protrusion.

11. The apparatus of claim 9, wherein each nonzero angle of the plurality of chip connection arrangements is 90 degrees.

12. A method comprising:
preparing a surface and a first layer of an interposer chip, where the surface of the interposer chip is substantially coplanar with a first plane and the first layer is below the surface of the interposer chip, by arranging a plurality of metal contacts on the surface of the interposer chip, a plurality of optical waveguiding structures in the first layer, and one or more cutout structures that extend from the surface of the interposer chip to the first layer and expose an end of a different respective optical waveguiding structure;
preparing a surface and a second layer of a device chip, where the surface of the device chip is substantially coplanar with a second plane and the second layer is below the surface of the device chip, by arranging a plurality of metal contacts on the surface of the device chip, a plurality of optical waveguiding structures in the second layer, and one or more protrusions extending from the device chip, where each protrusion contains at least a portion of a bend in a different respective optical waveguiding structure in the second layer and exposes an end of the optical waveguiding structure;
aligning the surface of the interposer chip and the surface of the device chip such that the first plane and the second plane form a nonzero angle;
aligning each of one or more protrusions of the device chip with a respective cutout structure on the surface of the interposer chip;
receiving alignment feedback associated with a coupling of ends of the optical waveguiding structures in the one or more protrusions to respective ends of the optical waveguiding structures exposed by the one or more cutout structures;
forming at least one connective structure between the device chip and the interposer chip based at least in part on the alignment feedback; and
forming a plurality of conductive structures between each of the metal contacts on the surface of the interposer chip and a respective metal contact on the surface of the device chip.

13. The method of claim 12, further comprising depositing a passivation layer on each of the conductive structures.

14. The method of claim 12, wherein the alignment feedback is associated with a coupling of ends of the optical waveguiding structures in two or more protrusions to respective ends of the optical waveguiding structures exposed by two or more cutout structures.

15. The method of claim 12, wherein the connective structure comprises ink, adhesive, or tacking fluid.

16. The method of claim 12, wherein an index matching material is placed between each of the ends of the optical waveguiding structures in the cutouts and the respective ends of the optical waveguiding structures in the protrusions.

17. The method of claim 12, wherein one or more optical waveguiding structures of the interposer chip comprise a spot-size converter configured to modify a cross-sectional area of an electromagnetic wave propagating through the respective optical waveguiding structure.

18. The method of claim 12, wherein the alignment feedback is associated with an electromagnetic wave propagating through one or more optical waveguiding structures of the interposer chip.

19. The method of claim 12, wherein one or more optical waveguiding structures of the interposer chip comprise a Sagnac loop.

20. The method of claim 12, wherein the conductive structures are deposited on the metal contacts arranged on the surface of the interposer chip before the surface of the interposer chip and the surface of the device chip are aligned.
